(19) United States
(12) Patent Application Publication
(10) Pub. No.: US 2012/0278150 A1
(43) Pub. Date: Nov. 1, 2012

(54) Method Employing Two-Sided Promotion for Uniting Clients With Businesses

(76) Inventor: Jimmy Chen, New York, NY (US)

(21) Appl. No.: 13/098,322

(22) Filed: Apr. 29, 2011

(51) Int. Cl. G06Q 30/00

(52) U.S. Cl. 705/14.19

(57) ABSTRACT

A system is provided for introducing customers to local businesses using incentives such as free goods or services. The system employs a server having a database and network communications and software capable of communicating with one or a plurality of user computing devices including a desktop, laptop, pad device, and smartphone. The system also includes inducements to the customers to continually provide valuable feedback to the business by limiting and increasing the number of incentives a user may have based on the number and quality of the feedback each user provides. Because the identities of the users visiting the businesses are known, the system provides a means to insure more constructive feedback to the businesses who are aware their identity is known, as opposed to the current mode where anonymous feedback is communicated which may be less than honest or actually placed by a competitor.

### BACKGROUND OF THE INVENTION

1. Field of the Invention

The present invention relates to promotion of the goods and services to remote clients communicating with computers, pad devices, and smartphones and the like, over a Wide Area Network such as the Internet. More particularly, it relates to a Web-based system for employing two-sided promotion of businesses through the provision of free goods and services to customers for businesses. The customers are provided free or steeply discounted goods and services as a try-before-you buy offer, from local merchants. In return, the customers subsequently provide a rating or review in continual feedback regarding merchants or business establishments after sampling their services or products. The system elicits more constructive feedback since the users are aware their identity is known to the system and posted feedback is thus more constructive than conventional posted feedback from unknown users.

2. Prior Art

The rise of the Internet and World Wide Web in the last decade, has changed the manner in which local business seek clients and compete in the marketplace. Concurrently, it has caused potential customers for local businesses to seek out local vendors for goods and services online. One problem in this model for local businesses, is the fact that the current web-based marketing systems, employ an intermediate process. That is to say, current web-based systems of advertising and marketing, seek to drive the customer to the website of the business first. Once the customer finds the website of the local business, a second step occurs because the website must attract the customer to actually visit the local business.

An additional shortcoming is that many such customers, in seeking a local business, also research the potential vendors they seek by seeking reviews and ratings of the customer's satisfaction of prior customers for the businesses being researched. However, for vendors, this review and rating system that has evolved, poses a problem because of the nature of customers.

There are several levels of customer including dissatisfied customers, satisfied customers, and loyal repeat customers. Satisfied customers are those that are generally happy with the vendor or establishment they frequent, but, they are open to the next better opportunity. Satisfied customers do not generally rate or review the establishment with which they are satisfied. Loyal customers are those that return despite offers elsewhere. However, loyal customers rarely review and rate the establishment they frequent on a regular basis. Dissatisfied customers are often quite a different prospect. Research has shown that for everyone that complains there are at least 25 who do not complain.

Research has also shown that dissatisfied customers, by word of mouth, and modernly by online reviews and ratings, will tell eight to sixteen others about their dissatisfaction. With the Internet, one such dissatisfied client or customer is now telling thousands of potential customers of their dissatisfaction with an establishment.

As can be seen, for a local business establishment, it is important to not only try and satisfy every client and customer, it is important in the era of web-reviews which reach thousands of local potential customers, to seek out reviews by satisfied loyal and regular customers as often as possible to negate the individual dissatisfied customer's postings that occur. Further, it is important for businesses to get new customers through marketing, but to also get input from as many customers as possible in their constant quest to improve customer service and resolve any problems that might occur before they escalate to a negative review.

However, local businesses lack worthy options when it comes to promoting and advertising their businesses to new clients likely to constructively review and rate their establishment once visited. Traditional advertising mediums such as mailers, flyers, local ads, radio, etc. are low returning efforts providing conversion rates of customers to outputted advertising which are quite low and often indeterminate. The advent of the World Wide Web has given businesses a number of new mediums by which to advertise, however the current web-provided solutions offered, are just as ineffectual as those offered by traditional media.

Conventionally provided online search engines offer solutions that are the most similar to the traditional model of print ads and promotions and distributed coupons as they provide a limited return on what can be a substantial investment for the local business to be “featured” on a search of local establishments by potential customers on the search engine. Similar results are obtained from social networking sites such as Facebook or Yelp, which promote businesses by allowing consumers to review and rate local businesses. Although these services usually cost little or nothing, the results therefrom are generally commensurate with the price.

More recently, numerous web sites have emerged which purport to help market local businesses digitally by offering discounted group buying coupons from what are supposed to be local businesses, to patrons and potential customers. Such offers have been known to yield an 80-90% conversion rate when distributed to customers with many clients enjoying discounted goods and services from local vendors. However, these special offers and coupons generally fail from the merchant standpoint in that they tend to “cheapen” the brand by placing in the mind of the customer, that coupons are always going to be available. Further, they leave no real, lasting, tangible residual benefit, and only attract new customers coming for discounts, and reviews therefor. The potential for customer feedback and posted bad reviews from a few individual new clients using coupons, is not offset by any increased input from current satisfied customers and loyal customers since they are not seeking coupons and do not participate.

As such, the current web-based marketing schemes all provide online solutions which are ineffectual. This occurs for two reasons. First as noted, such solutions attempt to drive the customer first to a website for local business, and then from the website to foot traffic into the business. Second, such conventional web-based systems offer one-sided models, for new customers seeking discounts and coupons, where the beneficiaries are often not the local businesses to whom these solutions are suppose to serve.

Consequently, there is a continuing and unmet need for a system that removes the middle step of potential customers having to find the local businesses website first, and provides a two-sided solution to web-based marketing which will service not only the customers and patrons, but also the businesses seeking them. Such a system should provide enthusiastic new customers through the employment of free goods or services, special offers, discounts through electronic or printed vouchers employable at local business establishments. Concurrently, such a system should also provide these local establishments who are providing the free or discounted goods and services, with guaranteed constructive customer feedback and reviews from a majority of the visiting customers, to thereby insure that they can monitor their customers' satisfaction and adjust their products and services to maximize such satisfaction. Further, such a system should provide for a high rate of customer reviews and input as a means to negate the very few dissatisfied clients who in the digital age, have far too much influence on potential buyers in the present system due to the fact the majority of such buyers do not rate businesses with which they are satisfied.

### SUMMARY OF THE INVENTION

The disclosed method herein disclosed and described provides a solution to the shortcomings in prior art and achieves the above noted goals through the provision of an online marketing system for opt-in users which is structured to remove the need for potential customers or users, to find a local website of a local business, and to insure feedback from a maximum number of users who visit the local business. Concurrently, the system provides a means to provide the introduction of a maximum number of those users as customers for local businesses through the provision of free services and products which are much more attractive than a simple discount coupon.

The disclosed system, employing a remote server communicating with users using computers, pad devices, smartphones, and other computing devices with displays over the internet, and employing software adapted to the task, provides users input screens which are configured to provide data about each consumer to a database hosted by the system. The database is provided with user information concerning at least geographic location, and preferably information about age, income, and business and service related preferences, so as to allow the system to ascertain offerings of free or discounted services and products from merchants that are geographically close to each user, which will also appeal to the user. For instance if the data gathered from a user indicates they are older and like Chinese food, an offer of free food at a local Chinese restaurant may be advanced to them during hours of the day where the user will find convenient. The system also employs software adapted to the task of providing businesses with a means of verifying user's identities whereby the business may verify arriving users with their photo ID such as a drivers license.

The business providers of goods and services will also be provided from the system server using software adapted to the task, the ability to sign up, and to enter information that may be stored on the system as to their geographic location at a minimum. Other information may be elicited and stored in the database on the system as to products or services provided and which the merchant may wish to promote or employ as a free offer in a promotion.

The users or consumers in a first step will sign up or opt in using the provided web page from the server which is displayable on the user's computer, pad, or smartphone or other computing device capable of network communication and having a display. Using their geographic location input such as a zip code or a Google Earth or other location designator, the users will be offered free or deeply discounted services and products from local businesses who as noted above have also signed up through the internet.

In return, each individual user will be required to write a review or testimonial on the business to which they are provided free products or services. The users will be limited to an initial maximum number of free services and goods from local merchants. In order to continue past this initial number, the users must provide reviews of the local businesses providing them. Once the user provides the required review or reviews, they can again receive free offers for more local goods and services. Over time, regular users who provide regular reviews and testimonials, will be unlocked and able to take advantage of a larger number of concurrent free deals. Increasing their ability to obtain concurrent free or discounted deals will provide users an incentive to write reviews and testimonials, as well as invest them in the system so as to make it more difficult for users to simply switch to another system and give up their senior status on the current one.

Additionally, the system may provide users with ever increasing award levels, for those who meet certain criteria, for example those users who have 100 reviews written many of which have been tracked by the system software as providing a high level of helpful reviews. These preferred user levels would allow users reaching them to be able to participate in limited number of premium super free deals not offered to lower tier users. Such premier deals might include free first class travel tickets and other high priced premium free goods and services. This premium labeling of users who are tracked by the software will provide users an incentive to try to be great users to the platform so that they can obtain these premium free deals.

Unlike many websites where anyone may upload a review, the testimonials or reviews of customers are by verified to be actual customers. This is because only those users who win free products and services, and use the free goods and services, are allowed to write the reviews. This will insure a higher quality of review information being provided to the providers of the goods and services over what is currently offered where anyone may review a product or service whether they have tried it or not.

Further, the system, employing software adapted to the task of tracking users and their use of free goods and services from subscribing vendors, will insure that each user is only provided a free or deeply discounted deal once, for any respective merchant or service provider on the system. This insures that the merchants and service providers are not taken advantage of by users who might wish to obtain free goods and services from a particular merchant on a regular basis.

As an example, if a new user has an initial threshold of 10 offers they may receive for free goods and services, once they are provided the offers, and before they will be offered any more such offers, the user must write at least one review of the services or products they have received from the local merchant offered them through the system. Employing software adapted to the task, the system herein will allow for the remote input of such reviews from users to the database. Thereafter, the user will be able to continue to receive new offers for free goods and services, until they hit the threshold number provided them, and have not provided the requisite review or reviews.

The system herein thus provides local business a means to promote themselves to localized customers in a manner that does not cheapen the brand like coupons. Further, the local businesses are provided a much higher rate of feedback from the customers since the customers are always trying to meet their threshold number to maintain their ability to receive free product and service offers.

The system will employ software adapted to provide customers an identifier of some sort, such as one or a combination of identifiers from a group consisting of I.D. cards, user names, user numbers, and the like. The information moves between the system server and the users using their computers, laptops, pad devices, smartphones, and other computing devices having memory, network communications, and display screens for graphic interfaces. In this fashion, the user only need show up for the goods or services, or call the merchant to do so, and provide the identifier. The system also provides the businesses with identifiers for customers who have been given the free goods or services so that they may ascertain that a customer presenting themselves or in person is supposed to receive such. Unlike a coupon that is presented without need to identify the presenter, the users in the system herein, are not totally anonymous as they have identifiers in the system. They will thus be less likely to “trash” the business who just provided them, locally, with free goods or services as can easily occur in the conventional manner where coupons or discount certificates are just presented to businesses by anonymous users.

The system generates revenue by charging a percentage of the value of the products provided to the users, and maintains the database and communicates the reviews and feedback to the businesses from the users.

The software employed to control the system may provide a home page of the system web site which will display top businesses by the ranking of their user ratings and their location. The achieved rankings for the participating businesses, may be based on an algorithm that rather than a simple average, instead takes into consideration the total number of reviews a business has received. This display and ranking system will provide the local merchants and service providers a means for advertisement based on their achieved ratings and encourage the providers to heed the reviews of the users. Employing software adapted to the task of geographic location of user and businesses, the displayed businesses may also be sorted by category and by distance to each respective user. Further, the software will allow registered users to search businesses by name so as to provide them with a means to ascertain user reviews about that business, and to ascertain if the business offers any users any free deals in return for reviews. Finally, as noted, the free deals and deep discounts will be location-based by proximity and/or zip code of a matched user and local business so that local businesses can target their offered deals to those in the neighborhood who are most likely to become repeat customers once they have sampled the goods and services for free and been satisfied.

Employing software adapted to the task running on the server, the home page of the system website herein may also display feature deals to users. Such feature deals will be displayed in a more prominent or more visible fashion to users. This will provide a means to get provider businesses to compete to be designated a feature deal since to be designated a featured deal, the business will have to offer the largest total value deal to users when compared to other business-offered deals which are available at the same time. The software may also provide potential users with emails or text messages of the local free or deeply discounted deals available that day to encourage them to participate as often as possible.

Further, the software running the system may provide other operating parameters for users of the system such as offering free services or products or deep discounts to users for businesses located proximately and doing so on a first come first served basis until a limited quantity being offered by businesses to local users is exhausted. Additionally, there might be offered a single daily free service or product, or multiple free deals each day. Or, the system can choose certain times during a day where the offered free services and products are offered, or a plurality of individual times during a day where the free services and products are offered to users. All of these software-provided parameters will insure users remain vigilant in their visits to the website since users may never know when one or a plurality of fantastic deals from a local merchant may be online.

To aid the service and goods providing businesses, the system employing software adapted to the task, will email or fax or text or otherwise electronically communicate a list of user-winners after the conclusion of their deal offer during any given day. This listing will be automatic and will provide the businesses with an easy-to-employ checklist to make sure that the free or deeply discounted products or services are only given to the rightful winners. Further, the providing businesses who participate in the system may also be provided with discount coupons to employ on their own as a means to attract additional paying users.

Additionally the providing businesses may be provided by the software running the system with an address book of the users that have previously won and employed a free deal with their establishment. This will provide the business with a means to follow up with potential good customers and to offer them additional product/service. In deciding who from the mailing list to contact, the businesses may be provided with a statistics listing which provides information concerning the interest level the individual users had on their free offers which would be a good predictor of the interest such users may have in a subsequent offer from the same business.

To aid the providing businesses in their quest for an excellent rating, and using software adapted to the task, the providing businesses may be allowed to provide follow-up comments on the reviews written by users. In order to allow readers of the system reviews a fair and balanced review process, the reviewing users may also be provided with a means to input a reply to the comments left by businesses. Once the users are able to review what the business has said about their review, they may be provided with an input screen where they may update their prior reviews and comments by posting new updates. However in order to maintain an unbiased system, the users will not be able to change their original reviews.

With respect to the above description of the two-sided discount and review system above, it is to be understood that the software and system herein is not limited in its application to the details of construction and to the arrangement of the steps and components in the description herein or illustrated in the drawings. The system herein described and employing free goods and services for consumers providing reviews of business providing them, is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of such systems.

It is an object of the invention to provide a system where local businesses and customers may be introduced to each other using free or deeply discounted goods and services and by eliciting prompt customer reviews.

It is another object of the invention to provide a means to drive local customers to local businesses without the need to have them find or visit the website of such businesses first.

A further object of the system herein is the provision of quality customer reviews of services and products to providers thereof to help the providers improve their businesses.

It is a further object of this invention, to elicit feedback for businesses from known users who will be more likely to provide reasonable input as opposed to conventionally provided unknown user feedback.

A further object of this invention is communication between users and the server and software running on the system, which allows users to employ desktop computers, laptops, pad devices, smartphones, and any other user computing device capable of network communications and having a display, to maximize the reach to users and interaction therewith.

These and other objects of the invention will become apparent upon further description of the preferred modes of the device set forth below.

### BRIEF DESCRIPTION OF DRAWING FIGURES

FIG. 1 is a simplified flow chart of the system herein.

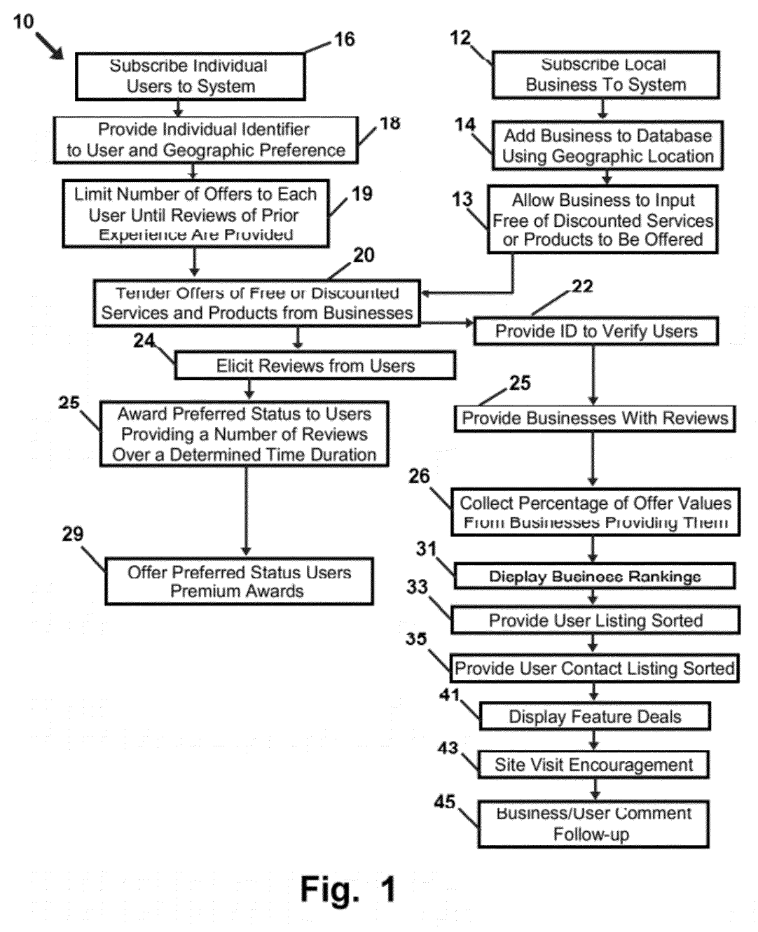

### DETAILED DESCRIPTION OF THE PREFERRED EMBODIMENTS OF THE INVENTION

The disclosed system 10 herein disclosed and described provides a solution to the shortcomings in prior art and achieves the above noted goals of removing the intermediary step local customers having to find a local business website to seek out a local merchant and perhaps find a discount offered by such local merchants. The system 10 does so through the employment of the disclosed online marketing system 10 which is software driven and configured for opt-in users and which employs software adapted to remove local business's need to first drive their potential customers or users to the website of their local business. The users, communicating with the system 10 using their desktop, laptop, pad device, smartphone, or other computing device having network communications and a display, by opting into the system 10, become known users who will provide repeat input for a plurality of businesses over time as part of the operation of the system 10. Because users are aware their identity is known to the system 10, and because their input is ongoing, they are more likely to provide constructive and meaningful feedback. This is apposed to conventional posted feedback on websites where users are unknown and may even be providing fake feedback about a competitor or their own business.

In one step 12, the business providers of goods and services will also be provided from the server operating the system 10, using software adapted to the task and resultant input screens, the ability to sign up, and to enter information that may be stored on the system as to their geographic location 14 at a minimum. Additional data 13 may be elicited initially and on an ongoing basis and stored in the database on the system 10 as to products or services provided by a business which they may wish to promote or employ as a free offer in a promotion.

In a user information gathering step 16, the disclosed system 10, employs the server which is in a remote communication with one or a combination of a desktop, laptop, pad device, or smartphone employed by the user, to communicate with users over the internet at their respective remote locations. In the case of a smart phone or pad device used by the user which is portable, GPS software running on the portable device may also be employed to inform the system 10 of the current or constant locations of the respective user to help tailor offers sent to the respective user.

Using software adapted to the task, the system 10 provides users input screens to elicit the required demographic data about each user to a database hosted by the system. In furtherance of this gathering step 16, demographic data concerning at least geographic location, and preferably information about age, income, and business and service related preferences, is gathered. The demographic data elicited in this step may also include information about age, income, and business and service related preferences, so as to allow the system a means to ascertain offerings of free or discounted services and products from merchants, that are both geographically close to each user and which based on gathered information, will also appeal to the user. Each user will then be provided with an identifier 18 and they will be matched to a geographic primary area. The system 10 also employs software to gather from the user, a means of verifying user identity so as to provide businesses a means to verify arriving users. Such verification may be by a photo ID such as drivers license. Further, the system 10 employing software adapted to the task, may gather user information concerning computing devices employable by the user such as desktop, laptop, pad devices, or smartphones, to allow the system 10 to more easily communicate with users, especially when on a mobile device such as a pad device or a smartphone. With GPS software running on most portable devices such as pad devices and smartphones, the user's immediate and constant destinations can be ascertained and offers can be sent to the user tailored to their travel habits or even current location when communicating over such devices with the system 10.

Next, in a limiting step, the users are designated with a maximum or threshold number 19 of offers 20 they may have without first providing a review of a prior business where they used the offer of free services or products. Users, employing their assigned identifier will use the free offers with businesses who are also provided with the identifier so as to know whom to serve based on their free offer.

The system 10, employing the user demographic input regarding geographic primary area, such as a zip code or a Google Earth or other location designator, and from a database of stored business offers of free or discounted services and products, the users are provided offers 20 for free or deeply discounted services and products from such local businesses. Means for identifying users accepting the offer 20 will be provided to businesses 22 to allow them to identify the proper users visiting for an offer 20.

To receive offers after the threshold, each individual user will be required to write a review 24 on the business to which they are provided free products or services which will be provided to the subscribing businesses. Regular users who provide regular reviews 24 and testimonials over a defined period, may have their threshold offers 19 maximum unlocked and able to take advantage of a larger number of concurrent offers 20. Increasing their ability to obtain concurrent free or discounted offers 20 will provide users an incentive to write reviews and testimonials, as well as invest them in the system 10 so as to make it more difficult for users to simply switch to another system and give up their senior status on the current one. The system 10 provides the reviews 24 to the businesses once input into the system 10.

The system 10, employing software adapted to the task of tracking users and their use of offers 20 from subscribing vendors, may be employed to insure that each user is only provided any given offer 20 once, for any respective merchant or service provider on the system. This provides a means to insure the merchants and service providers making offers 20 on the system 10, are not taken advantage of by users who might wish to obtain free goods and services from a particular merchant on a regular basis.

Additionally, the system 10 may provide users with a preferred status 25 and concurrent increasing award levels. This preferred status 25 will be provided for those who meet certain criteria, for example those users who have 100 reviews written many of which have been tracked by the system software as providing a high level of helpful reviews. These preferred status 25 can allow users to be able to participate in limited number of premium awards 29 not offered to lower tier users. Such premier awards 29 might include free first class travel tickets and other high priced premium free goods and services. This premium award 29 listing of users who are tracked by the software will provide users an incentive for all users to try to be great users to the system 10 to reach premium award 29 status.

The system 10 generates revenue by charging a percentage of the value of the products provided to the users 26. Other means for deriving revenue from the system 10 such as premier advertising and data provision of potential customers is anticipated within the scope of this application.

The system 10 may also employ software configured to provide a home page of the system 10 which will display top businesses by the rankings 31 based on their user ratings and their location. The achieved rankings 31 for the participating businesses, will preferably be based on an algorithm that rather than a simple average and take into consideration the total number of reviews a business has received. This display and ranking 31 within the system 10 if employed, will provide the local merchants and service providers a means for advertisement based on their achieved ratings and encourage the providers to heed the reviews of the users.

Optionally the system 10 employing software running on the server and adapted to produce sorted display pages based on database data may provide visitors sorted displays 33. The system 10 may provide the sorted displays 33, by employing software adapted to the task of sorting businesses by one or a plurality of sorting categories, including geographic proximity between users and businesses, business category of the businesses, rankings of a business by a particular threshold number of users, or by business name. This will allow users to ascertain from which businesses they may wish to visit locally or seek free or discounted deals.

Employing the stored data on the database, the system 10 may provide businesses a listing 35 of user contact information of matched users and local businesses so that the local businesses can target employ mail, or telephone, or text, or email, to otherwise provide offers 20 to those known users in the neighborhood who are most likely to become repeat customers once they have sampled the goods and services for free and been satisfied. Further, the listing 35 may include an address book of the users that have previously won and employed an offer 20 with their business establishment.

In another option, the system 10, employing software adapted to the task and running on the server, may customize a home page to display feature deals 41 to individual users. Such feature deals 41 will be displayed in a more prominent or more visible fashion to users. Featured deals will be calculated by ascertaining a total-value score which will be to aggregate total value of a particular free or discounted deal being offered by provider-businesses at a particular time during the day, and featuring one or a plurality of the deals offered having the highest actual value to buyers. This will provide a means to encourage provider-businesses to offer buyers deals with more value in order compete to be designated a feature deal 41 based on the largest total value to local users at a given time when compared to other deals 22. Since time of day is a factor some businesses will be able to time their best deals to become featured deals when other businesses are not offering the best discounts.

Optionally, but preferred as a means to encourage vigilance by users to the system 10 and continued and constant visits, the system 10 may provide other encouragement parameters for users of the system 10. Such encouragement parameters 43 may include one or a combination of offering free services or products or deep discounts to users proximate to businesses on a first come first served basis until a limited in quantity offered by businesses to local users is exhausted, or offering a single daily free service or product during a given time frame, or offering multiple free deals each day during determined time frames.

Finally, to aid the providing businesses in their quest for an excellent rating, the providing businesses may be allowed to provide follow-up comments 45 of the previous reviews written by users. In order to allow readers of the system reviews a fair and balanced review process, the reviewing users may also be provided with input screens for follow-up comments. However as noted, in order to maintain an unbiased system, the users will not be able to change their original reviews 24.

As noted, while all of the fundamental characteristics and features of the marketing system invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An incentive-based method for introducing customers to businesses and providing feedback to businesses providing incentive offers, said method employing a provider computer means having data storage means, network communications and means to communicate with users having one or a plurality of computing device including desktops, laptops, pad devices, and smartphones, and employing software adapted to the steps of:
communicating a graphic interface to a video display viewable by a remote user;
employing said graphic interface to elicit and communicate user information data, said user information data including at least user contact information, and a user location;
assigning a user-identifier to each respective said user providing said contact information;
storing respective said user information data related their respective user-identifier;
assigning each respective said, a user maximum number of said incentive offers which may be accepted without said respective user providing feedback on said offers;
inputting to said data storage means, incentive offers available to users from subscribing businesses, in combination with a provision-location, where each respective business provides said incentive offer;
matching said incentive offers and their respective provision-location with users having a proximate user-locations;
publishing said incentive offers in a manner viewable by said users;
allowing said users receiving said incentive offers to communicate acceptance;
upon communication of said acceptance, ascertaining said user is below said maximum number of said incentive offers accepted, and is therefor an eligible user;
communicating said user-identifier of said eligible user to said business providing said incentive offer as a means to identify arriving said users as eligible;
providing said users means to input said feedback regarding said business providing said incentive offer; and
providing said feedback from said users, to said respective business providing said incentive offer.

2. The incentive-based method of claim 1 additionally comprising the steps of:
employing said user contact information to publish said incentive offers by communicating respective said incentive offers only to respective said users having said user locations proximate to said provision-locations.

3. The incentive-based method of claim 2 additionally comprising the steps of:
publishing said incentive offers through a direct electronic communication to said user through email or texting to a smartphone.

4. The incentive-based method of claim 2 additionally comprising the steps of:
identifying each respective user upon a login by said user over said network communications; and
publishing said incentive offers by presenting each said user a customized webpage displaying only said incentive offers having a said provision-location which is proximate to said user.

5. The incentive-based method of claim 3 additionally comprising the steps of:
sending said direct electronic communication only to said users located proximate to said provision-location for said incentive offer.

6. The incentive-based method of claim 1 additionally comprising the step of:
tracking said incentive offers and preventing a said user from accepting a said incentive offer from the same said business more than once.

7. The incentive-based method of claim 2 additionally comprising the step of:
tracking said incentive offers and preventing a said user from accepting a said incentive offer from the same said business more than once.

8. The incentive-based method of claim 3 additionally comprising the step of:
tracking said incentive offers and preventing a said user from accepting a said incentive offer from the same said business more than once.

9. The incentive-based method of claim 4 additionally comprising the step of:
tracking said incentive offers and preventing a said user from accepting a said incentive offer from the same said business more than once.

10. The incentive-based method of claim 5 additionally comprising the step of:
tracking said incentive offers and preventing a said user from accepting a said incentive offer from the same said business more than once.

11. The incentive-based method of claim 1 additionally comprising the step of:
tracking said feedback from each respective user; and
increasing said maximum number for users who have provided said feedback for a high percentage of prior said incentive offers.

12. The incentive-based method of claim 2 additionally comprising the step of:
tracking said feedback from each respective user; and
increasing said maximum number for users who have provided said feedback for a high percentage of prior said incentive offers.

13. The incentive-based method of claim 3 additionally comprising the step of:
tracking said feedback from each respective user; and
increasing said maximum number for users who have provided said feedback for a high percentage of prior said incentive offers.

14. The incentive-based method of claim 4 additionally comprising the step of:
tracking said feedback from each respective user; and
increasing said maximum number for users who have provided said feedback for a high percentage of prior said incentive offers.

15. The incentive-based method of claim 5 additionally comprising the step of:
tracking said feedback from each respective user; and
increasing said maximum number for users who have provided said feedback for a high percentage of prior said incentive offers.

16. The incentive-based method of claim 6 additionally comprising the step of:
tracking said feedback from each respective user; and
increasing said maximum number for users who have provided said feedback for a high percentage of prior said incentive offers.

17. The incentive-based method of claim 1 whereby the step of providing said users means to input said feedback regarding said business providing said incentive offer provides a means to elicit more constructive said feedback to said businesses through the provision of said feedback from known users, and concurrent means to discourage fraudulent or competitor placed negative feedback.

18. The incentive-based method of claim 2 whereby the step of providing said users means to input said feedback regarding said business providing said incentive offer, provides a means to elicit more constructive said feedback to said businesses through the provision of said feedback from known users, and concurrent means to discourage fraudulent or competitor placed negative feedback.

19. The incentive-based method of claim 3 whereby the step of providing said users means to input said feedback regarding said business providing said incentive offer provides a means to elicit more constructive said feedback to said businesses through the provision of said feedback from known users, and concurrent means to discourage fraudulent or competitor placed negative feedback.

20. The incentive-based method of claim 4 whereby the step of providing said users means to input said feedback regarding said business providing said incentive offer provides a means to elicit more constructive said feedback to said businesses through the provision of said feedback from known users, and concurrent means to discourage fraudulent or competitor placed negative feedback.
